(19) United States
(12) Patent Application Publication
(10) Pub. No.: US 2018/0101010 A1
(43) Pub. Date: Apr. 12, 2018

(54) HEAD UP DISPLAY WITH IMPROVED IMAGE STABILITY

(71) Applicant: Panasonic Automotive Systems Company of America, Division of Panasonic Corporation of North America, PEACHTREE CITY, GA (US)

(72) Inventors: WALTER JOSEPH NILL, DAVISON, MI (US); DAVID KAY LAMBERT, STERLING HEIGHTS, MI (US); PETER CLARENCE SOHLDEN, SHELBY TOWNSHIP, MI (US)

(73) Assignee: Panasonic Automotive Systems Company of America, Division of Panasonic Corporation of North America

(21) Appl. No.: 15/726,438

(22) Filed: Oct. 6, 2017

Related U.S. Application Data
(60) Provisional application No. 62/405,320, filed on Oct. 7, 2016.

(51) Int. Cl. G02B 27/01; B60K 35/00; G02B 26/08; G02B 27/64

(52) U.S. Cl. CPC G02B 27/0149; B60K 35/00; G02B 26/0858; G02B 27/0101; G02B 27/646; B60K 2350/2052; G02B 2027/0159; B60K 2350/1072; B60K 2350/352; B60K 2350/921; G02B 2027/011; G02B 2027/014; B60K 2350/2065

(57) ABSTRACT

A motor vehicle includes a head up display projector producing a light field such that the light field is reflected off of a windshield of the motor vehicle and is then visible to a driver of the motor vehicle as a virtual image. A sensor measures an effect of vibration on the motor vehicle and transmits a sensor signal dependent upon the measured effect. An actuator is coupled to the head up display projector and moves a component of the head up display projector such that a position and/or orientation of the virtual image as perceived by the driver is changed. An electronic processor is communicatively coupled to each of the head up display projector, the sensor and the actuator. The electronic processor receives the sensor signal and controls the actuator dependent upon the sensor signal such that the virtual image appears to be unaffected by the vibration.

This application claims the benefit of U.S. Provisional Application No. 62/405,320, filed on Oct. 7, 2016, which the disclosure of which is hereby incorporated by reference in its entirety for all purposes.

### FIELD OF THE INVENTION

The disclosure relates to a head up display (HUD) in a motor vehicle.

### BACKGROUND OF THE INVENTION

A head up display emits light that reflects from the front windshield to be seen by the driver. The light appears to come from a virtual image in front of the driver and in front of the windshield. This type of head up display is currently commercially available.

Conventional head up displays create the virtual image by first using a display to create an image. Next, the light from the image is reflected from one or more mirrors. Next, the light from the mirrors is reflected from the windshield. The mirrors are designed and positioned relative to the display so that the light seen by the driver, which is reflected from the windshield, appears to come from a virtual image that is outside of the vehicle. The mirrors and display are typically contained in a package that occupies a volume beneath the top surface of the dashboard.

The effect of an uneven or bumpy road is to shake, vibrate and rotate the frame of a vehicle traveling on the road. The vehicle suspension is designed to reduce the effect of these inputs on the vehicle structure. As an example, luxury vehicles may be designed with a soft suspension. Sports cars may be designed with a hard suspension. Regardless of the type of suspension, the frame of the vehicle will still move in response to bumpy roads. If the bumps are large enough, the inputs to the suspension may exceed the suspension's range of allowable travel, causing even larger vibrations of the vehicle structure.

Depending upon the magnitude of the shock, vibration, translation or rotation applied to the vehicle structure, the perceived position or orientation of the virtual image, as seen by the driver, may vary as a function of time, resulting in a less desirable perceived image. In particular, the effect of the bumpy road may impart forces on the structure of the vehicle so that the positions of individual pixels in the virtual image move enough over time to cause the image to be perceived by the driver to be blurred.

In order to avoid the effect of vibration on the HUD virtual image, the current practice is to make the HUD itself rigid, including the components inside the HUD. For example, a spring is used to remove backlash from the gear train of the stepper motor that is used in the HUD to adjust the vertical position of the virtual image. The HUD package typically uses plastic ribs to minimize deflection of the package. A problem that cannot be corrected by making the HUD rigid is that travel on a bumpy road causes the entire HUD package and the windshield to move, resulting in motion of the virtual image as perceived by the driver.

Image stabilization systems are currently used with commercially available cameras. Typically, the image stabilization systems include a sensor that measures rotation of the camera, and a means to stabilize the image. In this case, motion of the person holding the camera is the source of the image movement that needs to be corrected.

Platforms on which cameras are mounted have also been stabilized relative to a moving vehicle. These are used, for example, on tanks to enable the tanks to accurately fire at targets.

### SUMMARY

The present invention may improve the perceived sharpness of the virtual image of a windshield head up display (HUD), as seen by the driver, operated in a vehicle traveling on an uneven or bumpy road surface.

In one embodiment, the invention comprises a motor vehicle including a head up display projector producing a light field such that the light field is reflected off of a windshield of the motor vehicle and is then visible to a driver of the motor vehicle as a virtual image. A sensor measures an effect of vibration on the motor vehicle and transmits a sensor signal dependent upon the measured effect. An actuator is coupled to the head up display projector and moves a component of the head up display projector such that a position and/or orientation of the virtual image as perceived by the driver is changed. An electronic processor is communicatively coupled to each of the head up display projector, the sensor and the actuator. The electronic processor receives the sensor signal and controls the actuator dependent upon the sensor signal such that the virtual image appears to be unaffected by the vibration.

In another embodiment, the invention comprises a display method for a motor vehicle, including producing a light field such that the light field is reflected off of a windshield of the motor vehicle and is then visible to a driver of the motor vehicle as a virtual image. An effect of vibration on the motor vehicle is measured. A sensor signal is transmitted dependent upon the measured effect. The producing of the light field is adjusted dependent upon the sensor signal such that the virtual image appears to be unaffected by the vibration.

In yet another embodiment, the invention comprises a motor vehicle including a head up display projector producing a light field such that the light field is reflected off of a windshield of the motor vehicle and is then visible to a driver of the motor vehicle as a virtual image. A sensor measures an effect of vibration on the motor vehicle and transmits a sensor signal dependent upon the measured effect. An electronic processor is communicatively coupled to the head up display projector and to the sensor. The electronic processor receives the sensor signal and adjusts the light field dependent upon the sensor signal such that the virtual image appears to be unaffected by the vibration.

An advantage of the present invention is that it may enable a HUD to provide a crisp, pleasing image to the driver while a vehicle is driven on a bumpy road.

### BRIEF DESCRIPTION OF THE DRAWINGS

A better understanding of the present invention will be had upon reference to the following description in conjunction with the accompanying drawings.

FIG. 1 is a schematic side view of one embodiment of a motor vehicle including a head up display arrangement of the present invention.

FIG. 2 is a block diagram of one embodiment of a feedback loop incorporated in the head up display arrangement of FIG. 1 to stabilize a virtual image.

FIG. 3 is a flow chart of one embodiment of a display method of the present invention for a motor vehicle.

### DETAILED DESCRIPTION OF THE PREFERRED EMBODIMENTS

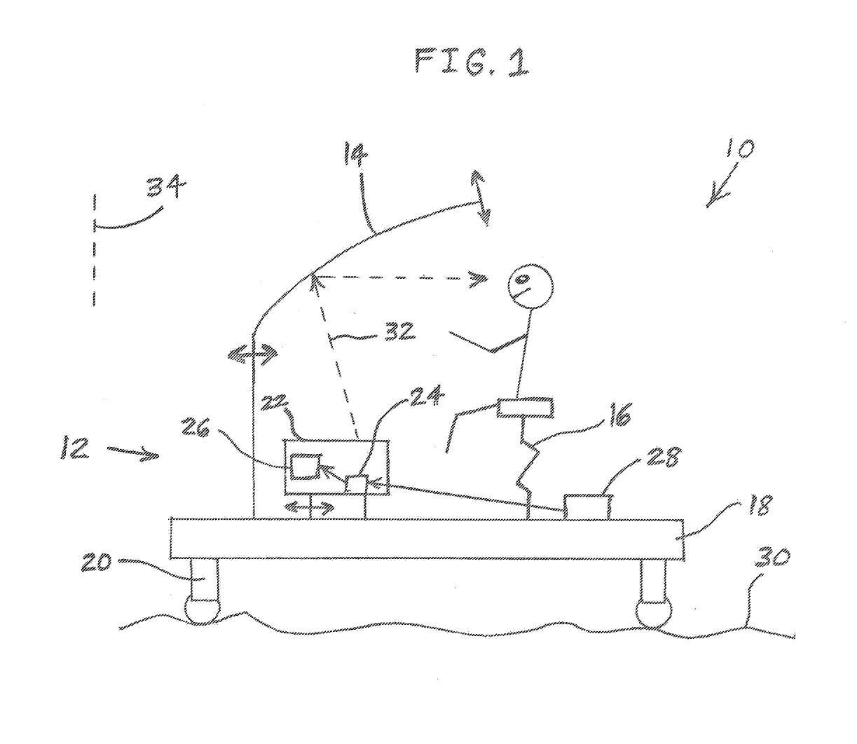

FIG. 1 illustrates one embodiment of a motor vehicle 10 of the present invention, including a head up display arrangement 12, a windshield 14, a driver's seat 16, a frame 18, and a suspension system 20. Head up display arrangement 12 includes a HUD light projector 22, having an electronic processor or controller 24 and an actuator 26. Head up display arrangement 12 also includes a motion sensor 28.

While vehicle 10 is driven on a bumpy road 30, frame 18 of vehicle 10 is partially isolated from induced road motion by suspension 20, but frame 18 still moves in response to vehicle 10 being driven on bumpy road 30. HUD projector 22 projects a light field 32 that reflects from windshield 14 to be seen as a virtual image 34 in front of vehicle 10.

HUD light projector 22 and windshield 14 both move in response to traveling on a bumpy road. Consequently, if not for the present invention, the driver would perceive motion of virtual image 34, causing virtual image 34 to not appear to be sharp. One or more sensor(s) 28 attached to vehicle frame 18 detect the motion of vehicle 10 that is caused by the bumpy road. Sensor(s) 28 may, for example, be disposed inside a HUD package or may be the same sensors that are already conventionally used on vehicles for other purpose(s).

Controller 24 determines the linear response needed to cancel out, or compensate for, the perceived motion of virtual image 34, and sends appropriate signals to one or more actuators 26. Examples of sensors 28 include a strain gauge attached to vehicle frame 18, a linear accelerometer, or a gyroscope. Examples of actuators 26 include a stepper motor to rotate a mirror (not shown) in the HUD package, and a piezoelectric device to translate the display that creates the HUD image. Alternatively, the HUD virtual image may be translated by using software to change the location of the image on the display.

A novel aspect of this invention may be that a sensing means is used to measure one or more of the following parameters associated with the effects of the bumpy road on the vehicle: a deformation of the vehicle; a component of force; linear acceleration along a direction; and angular rotation about an axis. Another novel aspect of this invention may be that the output of one or more sensor means is used as a linear input to one or more of the following image correction means: (1) the image displayed on the display that creates the virtual image is translated and/or rotated on the display to correct the perceived translation and/or rotation of the virtual image; and (2) one or more components of the HUD are translated or rotated to compensate for the perceived translation of the virtual image. The means of mechanical compensation may include the adjustment mechanism used to adjust the virtual image to compensate for driver height, such as a stepper motor that rotates a mirror about an axis. The means of mechanical compensation may also include a mechanical means to move the display used to create the HUD image. The means of image translation on the display may make use of a known apparatus that also compensates for image distortion, which is already included in conventional HUD systems.

The sensor means used to measure the motion input may already be included in the vehicle for a different purpose. For example, an accelerometer normally used to detect a crash could be used as an input for the inventive system. Alternatively, a gyroscope normally used to stabilize a camera could be used as an input for the inventive system.

In one embodiment, the sensor means to measure mechanical motion is directly attached to a mirror in the HUD, to make it possible to compensate for motion of the mirror relative to the HUD package.

Another novel aspect of this invention is that there may be criteria or a trigger to activate the system. For example, the system may not compensate for road vibrations unless a threshold level of road vibration is exceeded. The criteria may include hysteresis and/or a time delay in order to avoid frequent switching of the system on and off, for example.

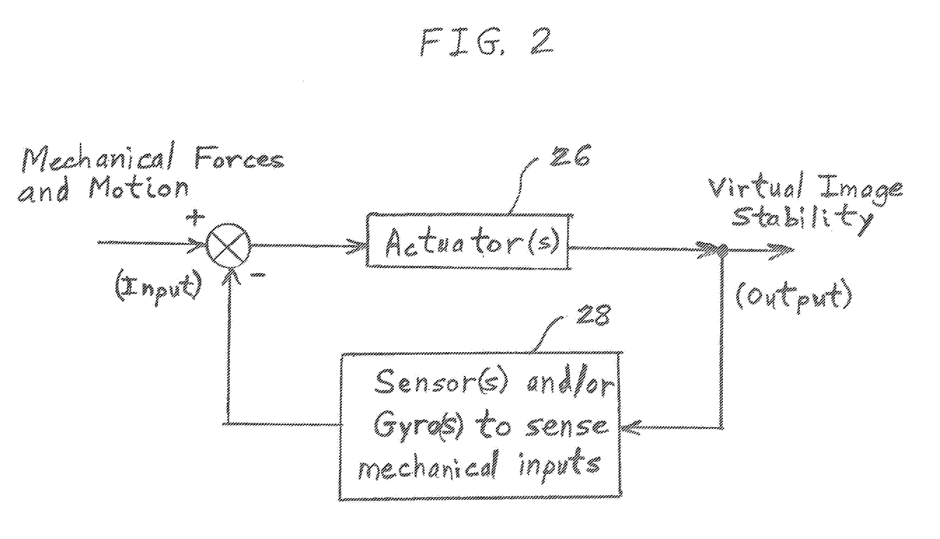

The inventive system may include a feedback loop to stabilize the virtual image, as seen by the driver. A feedback loop to stabilize the perceived virtual image is shown schematically in FIG. 2.

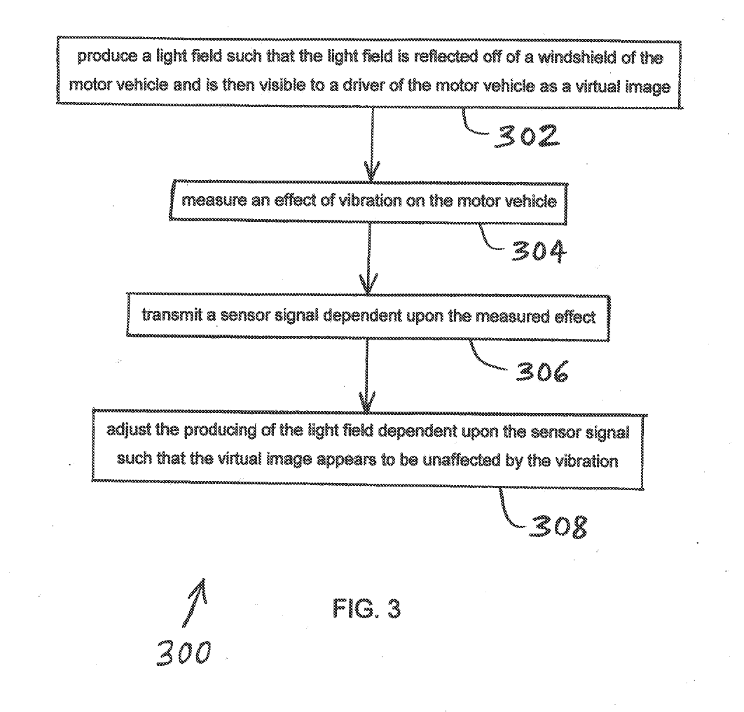

FIG. 3 illustrates one embodiment of a display method 300 of the present invention for motor vehicle 10. In a first step 302, a light field is produced such that the light field is reflected off of a windshield of the motor vehicle and is then visible to a driver of the motor vehicle as a virtual image. For example, HUD projector 22 projects a light field 32 that reflects from windshield 14 to be seen as a virtual image 34 in front of vehicle 10.

Next, in step 304, an effect of vibration on the motor vehicle is measured. For example, one or more sensor(s) 28 attached to vehicle frame 18 detect the motion of vehicle 10 that is caused by the bumpy road.

In a next step 306, a sensor signal is transmitted dependent upon the measured effect. For example, sensor 28 may transmit a signal dependent upon the detected motion of vehicle 10.

In a final step 308, the producing of the light field is adjusted dependent upon the sensor signal such that the virtual image appears to be unaffected by the vibration, For example, controller 24 determines the linear response needed to cancel out, or compensate for, the perceived motion of virtual image 34, and sends appropriate signals to one or more actuators 26. Examples of actuators 26 include a stepper motor to rotate a minor in the HUD package, and a piezoelectric device to translate the display that creates the HUD image.

According to the invention, the translations and rotations of the vehicle structure as a function of time are mapped to proportional translations and rotations of the virtual image. The present invention uses a compensating means to decrease the apparent motion of the virtual image, as viewed by the driver, reducing or eliminating the perceived blur of the virtual image.

It should also be understood that the system of this invention has an upper amplitude limit of protection. If the amplitude exceeds this limit, protection will be compromised. However, the system is designed with a range of protection that significantly improves the experience of the driver.

The driver's body may compensate for vibration of the driver's head. However, in one embodiment, the vibration of the driver's head is sensed or estimated and then compensated for.

The foregoing description may refer to “motor vehicle”, “automobile”, “automotive”, or similar expressions. It is to be understood that these terms are not intended to limit the invention to any particular type of transportation vehicle. Rather, the invention may be applied to any type of transportation vehicle whether traveling by air, water, or ground, such as airplanes, boats, etc.

The foregoing detailed description is given primarily for clearness of understanding and no unnecessary limitations are to be understood therefrom for modifications can be made by those skilled in the art upon reading this disclosure and may be made without departing from the spirit of the invention.

What is claimed is:

1. A motor vehicle, comprising:
a head up display projector configured to produce a light field such that the light field is reflected off of a windshield of the motor vehicle and is then visible to a driver of the motor vehicle as a virtual image;
a sensor configured to measure an effect of vibration on the motor vehicle and transmit a sensor signal dependent upon the measured effect;
an actuator coupled to the head up display projector and configured to move a component of the head up display projector such that a position and/or orientation of the virtual image as perceived by the driver is changed; and
an electronic processor communicatively coupled to each of the head up display projector, the sensor and the actuator, the electronic processor being configured to:
receive the sensor signal; and
control the actuator dependent upon the sensor signal such that the virtual image appears to be unaffected by the vibration.

2. The motor vehicle of claim 1 wherein the motor vehicle comprises a frame, the sensor including a strain gauge attached to the frame.

3. The motor vehicle of claim 1 wherein the sensor includes a linear accelerometer.

4. The motor vehicle of claim 1 wherein the sensor includes a gyroscope.

5. The motor vehicle of claim 1 further comprising a mirror configured to reflect the light field from the head up display projector onto the windshield, the actuator including a stepper motor configured to rotate the mirror.

6. The motor vehicle of claim 1 wherein the actuator includes a piezoelectric device configured to translate the head up display projector.

7. The motor vehicle of claim 1 further comprising a mirror configured to reflect the light field from the head up display projector onto the windshield, the sensor being attached to the mirror.

8. A display method for a motor vehicle, the method comprising:
producing a light field such that the light field is reflected off of a windshield of the motor vehicle and is then visible to a driver of the motor vehicle as a virtual image;
measuring an effect of vibration on the motor vehicle;
transmitting a sensor signal dependent upon the measured effect; and
adjusting the producing of the light field dependent upon the sensor signal such that the virtual image appears to be unaffected by the vibration.

9. The method of claim 8 wherein the measuring is performed by use of a strain gauge attached to a frame of the motor vehicle.

10. The method of claim 8 wherein the measuring is performed by use of a linear accelerometer.

11. The method of claim 8 wherein the measuring is performed by use of a gyroscope.

12. The method of claim 8 further comprising reflecting the light field from a head up display projector onto the windshield by use of a mirror, the adjusting step including rotating the mirror by use of a stepper motor.

13. The method of claim 8 wherein the projecting step is performed by a head up display projector, the adjusting step including translating a head up display projector by use of a piezoelectric device.

14. The method of claim 8 further comprising reflecting the light field from a head up display projector onto the windshield by use of a mirror, the measuring step being performed by a sensor attached to the mirror.

15. A motor vehicle, comprising:
a head up display projector configured to produce a light field such that the light field is reflected off of a windshield of the motor vehicle and is then visible to a driver of the motor vehicle as a virtual image;
a sensor configured to measure an effect of vibration on the motor vehicle and transmit a sensor signal dependent upon the measured effect; and
an electronic processor communicatively coupled to the head up display projector and to the sensor, the electronic processor being configured to:
receive the sensor signal; and
adjust the light field dependent upon the sensor signal such that the virtual image appears to be unaffected by the vibration.

16. The motor vehicle of claim 15 wherein the motor vehicle comprises a frame, the sensor including a strain gauge attached to the frame.

17. The motor vehicle of claim 15 wherein the sensor includes a linear accelerometer.

18. The motor vehicle of claim 15 wherein the electronic processor is configured to: estimate vibration of the driver's head; and
adjust the light field dependent upon the estimated vibration of the driver's head such that the virtual image appears to be unaffected by the vibration of the driver's head.

19. The motor vehicle of claim 18 wherein the sensor comprises a first sensor, the motor vehicle comprising a second sensor configured to detect the vibration of the driver's head, the electronic processor being configured to perform the estimation of the vibration of the driver's head dependent upon an output of the second sensor.

20. The motor vehicle of claim 15 further comprising a mirror configured to reflect the light field from the head up display projector onto the windshield, the sensor being attached to the minor.
